(19) United States
(12) Patent Application Publication
(10) Pub. No.: US 2007/0051413 A1
(43) Pub. Date: Mar. 8, 2007

(54) PRINTING MACHINE CLEANING DEVICE, FLUID SYSTEM AND DISTRIBUTOR VALVE THEREFOR

(75) Inventors: Thorsten SCHMUTZ, Bobingen (DE); Arnold GOLD, Friedberg (DE); Jurgen KOHN, Gablingen (DE); Siegbert NADOLNY, Meitingen (DE); Martin MAIER, Augsburg (DE); Jorgen HELLBORG, Aslöv (SE); Frank MANSSON, Malmö (SE)

Correspondence Address: MORGAN & FINNEGAN, L.L.P., 3 WORLD FINANCIAL CENTER, NEW YORK, NY, 10281-2101, US

(73) Assignee: BALDWIN GERMANY GMBH, Augsburg (DE)

(21) Appl. No.: 11/470,139

(22) Filed: Sep. 5, 2006

(30) Foreign Application Priority Data
Sep. 6, 2005 (DE) 10 2005 042 300.0

(51) Int. Cl. F16K 11/07

(52) U.S. Cl. 137/625.48

(57) ABSTRACT

A fluid system (4) of a printing machine cleaning device (6) has at least one distributor valve (2) with an inlet (8), at least two outlets (10), a locking element (12) and a locking element seat (14). The at least two outlets (10) are each simultaneously separated, in terms of flow, from the inlet (8) or simultaneously connected, in terms of flow, to the inlet (8).

### CROSS-REFERENCE TO RELATED APPLICATIONS

This application claims priority under 35 USC 119 of German application No. DE 10 2005 042 300.0, filed on Sep. 6, 2005.

### SUMMARY OF THE INVENTION

The invention relates to a printing machine cleaning device for cleaning cylinders and rollers of printing machines, especially offset printing machines. The invention also relates to a fluid system for a printing machine cleaning device, as well as a distributor valve for a liquid system of this type.

The object of the invention is to guarantee controlled media and spray distribution in a printing machine cleaning device. This object is attained according to the invention by the features of claims 1, 5, 9 and 10. Additional features of the invention are provided in the subordinate claims.

The invention is described below with reference to the drawings and on the basis of preferred embodiments as examples.

### BRIEF DESCRIPTION OF THE DRAWINGS

FIG. 1 shows schematically, a sectional view of a distributor valve according to the invention,

FIG. 2 shows schematically, an embodiment of a fluid system of a printing machine cleaning device according to the invention;

FIG. 3 shows schematically, another embodiment of a fluid system of a printing machine cleaning device according to the invention.

In the drawings, identical or identically acting elements are identified by the same reference numbers.

### DETAILED DESCRIPTION

A fundamental idea of the present invention is to segment a fluid delivery device 36, which is provided for the delivery of fluid onto a wash cloth of a printing machine cleaning device 6 or onto a rotational body of a printing machine, into at least two, preferably at least three or more fluid delivery segments 38. Another fundamental idea of the invention is to uniformly supply the fluid delivery segments 38 formed in this manner.

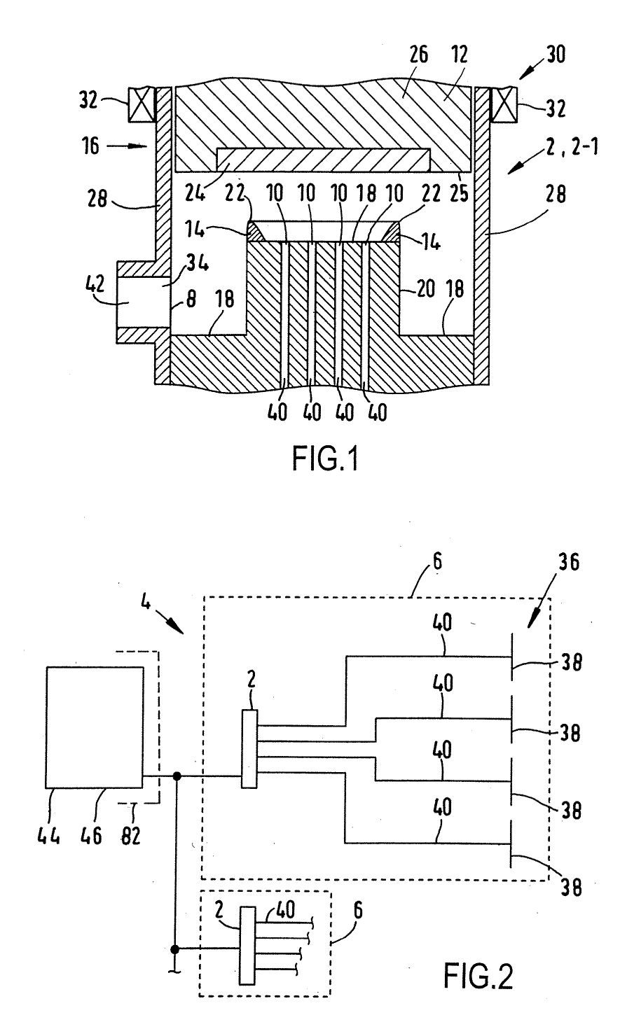

FIG. 1 shows an exemplary embodiment of an inventive distributor valve 2 of a fluid system 4 of a printing machine cleaning device 6. A printing machine cleaning device 6 within the meaning of this invention is designed to clean rotational objects, such as cylinders or rollers of a printing machine, especially an offset printing machine.

A fluid for a printing machine cleaning device 6 can be, for example, fresh water, cleaning fluid, UV cleaning fluid, solvent or a mixture or emulsion of two or more of the aforementioned substances. All materials of the distributor valve 2 coming into contact with the fluid are made of materials resistant to the respective fluid.

The distributor valve 2 contains an inlet 8, at least two outlets 10, a locking element 12 and a locking element seat 14. Preferably, the distributor valve 2 contains at least three outlets 10, such as four outlets 10, as shown in FIG. 1. In a locked position, the locking element 12 interacts with the locking element seat 14 to separate the at least two outlets 10 from the inlet 8 in terms of flow. In an open position 16 of the locking element 12, the at least two outlets 10 are connected to the inlet 8 in terms of flow. The locking element 12 interacts with the locking element seat 14, that is, the locking element 12 and the locking element seat 14 are designed and arranged so as to simultaneously separate each of the at least two outlets 10 from the inlet 8 in terms of flow. In addition, the locking element 12 interacts with the locking element seat 14, that is, the locking element 12 and the locking element seat 14 are designed and arranged so as to simultaneously separate each of the at least two outlets 10 from the inlet 8 in terms of flow.

The distributor valve of the invention ensures that the same fluid volume is delivered (dosed) through each of the outlets 10 as a result of one opening of the distributor valve, that is, as a result of one placement of the locking element into the open position for a specific time period. This ensures controlled media and spray distribution.

According to the exemplary embodiment shown, each of the outlets 10 extends away from a valve seat 18. The locking element 12 is moveable toward the valve seat 18 into the locking position and away from the valve seat 18 into the open position 16.

The valve seat 18 can have a protrusion 20 in the direction of the locking element 12 in the region of the outlets 10, as shown in FIG. 1. Alternatively, the valve seat 18 can be flat (not shown).

The locking element seat 14 preferably extends completely around the at least two outlets 10. The outlets 10 can be arranged in a line or in another layout. In FIG. 1, the locking element seat 14 consists of a protrusion 22 that extends from the valve seat 18 in the direction of the locking element 12. The protrusion 22 forming the locking element seat 14 can be wedge-shaped in cross-section, as shown in FIG. 2. Alternatively, the locking element seat 14 can consist of a flat valve seat part, for instance the valve seat part of the protrusion 20.

The locking element seat 14 can be designed to be rigid, consisting, for example, of a rigid material, at least in a section opposite the locking element 12, while the locking element 12 is designed to be elastic, consisting, for example, of an elastically compressible material, at least in a section opposite the locking element seat 14. In particular, as in the embodiment shown in FIG. 1, the locking element seat 14 can consist entirely of a rigid material and the section 24 of the locking element 12 opposite the locking element seat 14 can consist of the elastically compressible material, in this case an elastic insert.

Conversely, the locking element seat 14 can be designed to be elastic, consisting, for example, of the elastically compressible material, at least in a section opposite the locking element 12, while the locking element 12 is designed to be rigid, consisting, for example, of the rigid material (not shown), at least in a section opposite the locking element seat 14. A rigid material can, for example, be a metal or a hard plastic, especially Plexiglas. An elastically compressible material can, for example, be a soft plastic or rubber.

In the embodiment shown in FIG. 1, the locking element 12 has a piston 26 that is arranged in a sleeve formed by a valve wall 28. In the piston, the elastic insert 24 is arranged in a groove opposite the locking element seat 14, the insert 24 being flush with a piston head 25. The valve wall 28 is connected to the valve seat 18, by being screwed to it, for example, or is formed integral with the valve seat 18. In the exemplary embodiment shown, the sleeve formed by the valve wall 28 is cylindrical with a circular cross-section.

The locking element 12 can also have a flexible membrane or be made from a flexible membrane. In addition, the locking element 12 can be made in any other suitable manner.

To activate the locking element 12 of the inventive distributor valve 2, any control mechanism 30 can be provided to establish the open position 16 and the locked position. The control mechanism 30 can be a standard magnetic valve, for example. Alternatively, the control mechanism can be operated pneumatically, hydraulically or mechanically.

The exemplary control mechanism 30 in FIG. 1 contains an elastically compressible element (not shown), a spring, for example, that prestresses the distributor valve 2 in the locked position. A magnetic field that can be generated by a coil array 32 of the control mechanism 30 acts on a magnetizable or permanently magnetic material of the control mechanism 30 that is arranged on or in the locking element 12 or is formed by the locking element 12, and forces the locking element 12 against the prestress force of the elastically compressible element and into the open position 16 shown in FIG. 1. The piston 26, for example, can be made of magnetizable material.

The inlet 8 of the distributor valve 2 can be formed in the valve wall 28. The inlet 8 contains at least one inlet opening, such as a single inlet opening 34, as shown in FIG. 1. Diverging from the exemplary embodiment shown, the at least one inlet opening can be arranged in any other manner.

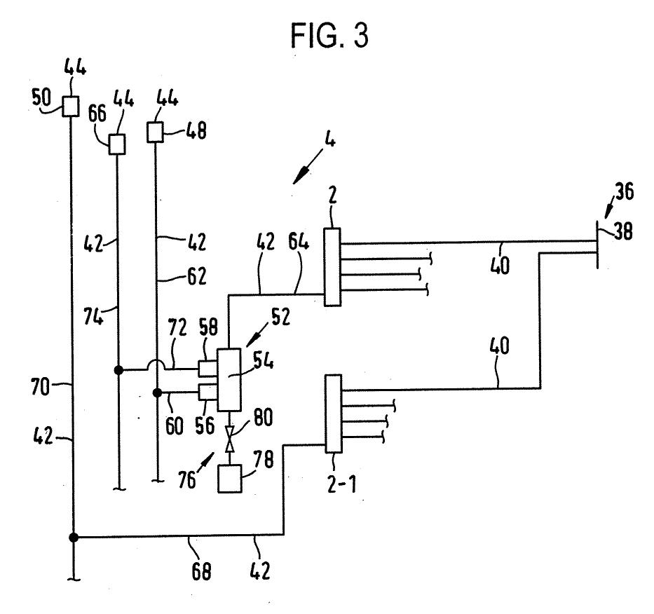

FIG. 2 and FIG. 3 show an inventive fluid system 4 of a printing machine cleaning device 6. The fluid system 4 contains a fluid delivery device 36, such as a spray tube or a membrane of a wash cloth placement element, each having at least two fluid delivery segments 38 for the delivery of fluid. The fluid delivery segments 38 are preferably arranged so that when the printing machine cleaning device 6 is properly positioned in a printing machine, the fluid delivery segments 38 are distributed across the span of a cylinder or a roller of the printing machine. The length of the fluid delivery segments 8 can be between 5 cm and 50 cm, for example, preferably between 10 cm and 30, especially 20 cm.

The delivery or spraying of the fluid through the fluid delivery segments 38 is achieved through the media pressure.

The fluid delivery segments 38 can be formed, for example, by suitably placed stoppers in the spray tube or in the membrane. The fluid delivery system 4 also contains a distributor valve 2, wherein, of the least two outlets 10 of the distributor valve 2, a dedicated outlet 10 is assigned to each of the fluid delivery segments 38, and each outlet 10 of the distributor valve 2 is connected, in terms of flow, to the fluid delivery segment 38 assigned to it via a separate outlet flow path 40, as shown in FIG. 2. Alternatively, each outlet 10 of the distributor valve 2 can be connectable, in terms of flow, to the fluid delivery segment 38 assigned to it via a separate outlet flow path 40.

For its fluid supply, the distributor valve 2 is connected or connectable, in terms of flow, to the fluid source 44 via an inlet flow path 42 that extends between the inlet 8 of the distributor valve 2 and a fluid source 44. A fluid source 44 can be a pressurized fluid source, such as a pressurized container 46, as shown in FIG. 2, or a pressurized fluid connection, for example. In the pressurized container 46, pressure known as media pressure can be applied to the fluid to be dosed by the distributor valve 2, so as to pump the fluid through the distributor valve 2 to the fluid delivery device 36, when the distributor valve 2 is open, and to deliver the fluid through fluid delivery openings. Each fluid delivery segment 38 contains at least one fluid delivery opening, such as a single fluid delivery opening. In addition, each fluid delivery segment 38 can contain a plurality of fluid delivery openings.

At least one additional printing machine cleaning device 6 with an inventive distributor valve 2 can be connected to the pressurized container 2, as shown in FIG. 2. For example, three or more printing machine cleaning devices 6 can be connected to the pressurized container. The printing machine cleaning device 6 and the at least one additional printing machine cleaning device 6 can be arranged in different printing plants.

In addition to the one distributor valve 2 described above, each fluid system 4 can have at least one additional distributor valve 2-1, for example, that is designed inventively, preferably to match the one distributor valve 2, as shown in FIG. 3. Of the at least two outlets 10 of the additional distributor valve 2-1, a dedicated outlet 10 is assigned to each of the fluid delivery segments 38 of the fluid delivery device 36, and each outlet 10 of the additional distributor valve 2-1 is connected, in terms of flow, to the fluid delivery segment 38 assigned to it through a separate outlet flow path 40.

As a result, each fluid delivery segment 38 is connected to two distributor valves 2, 2-1 via a dedicated outlet flow path 40. Each of the two distributor valves 2, 2-1 is preferably connected or connectable, in terms of flow, to one other fluid source 44. For example, the one distributor valve 2 can be connected, in terms of flow, to a first fluid source 48, such as a UV cleaning fluid source, and the other distributor valve 2-1 can be connected, in terms of flow, to a second fluid source 50, such as a water source, especially a pressurized water line. Thus, depending on which of the distributor valves 2, 2-1 is open, each fluid delivery segment 38 of the fluid delivery device 36 can either deliver water or, for example, UV cleaning fluid. Switching between the fluid from the first fluid source 48 and the fluid from the second fluid source 50, such as switching from water to UV cleaning fluid, can be done within a short period of time. This is especially important with cleaning programs involving water and cleaning agent.

According to an embodiment that is not shown, a dedicated distributor valve and a dedicated fluid delivery device 36 assigned to the respective distributor valve can be provided for each fluid. For example, at least one additional fluid delivery device can be provided, wherein, of the at least two outlets 10 of an additional distributor valve, of the one additional distributor valve 2-1, for example, a dedicated outlet 10 is assigned to each of the fluid delivery segments of the additional fluid delivery device, and each outlet 10 of the additional distributor valve 2-1 is connected, in terms of flow, to the fluid delivery segment assigned to it via a separate outlet flow path.

Each of the outlet flow paths of a distributor valve 2, 2-1 preferably has essentially identical flow resistance for the respective fluid. The fluid system 4 shown in FIG. 4 also has a valve array 52 with a valve array outlet flow path 54 and at least two valves, such as a first valve 56 and a second valve 58. The valves 56, 58 of the valve array 52 are optionally connectable, in terms of flow, to the valve array outlet flow path 54. The valve array outlet flow path 54 of the valve array 52 is connected or connectable, in terms of flow, to the inlet 8 of the distributor valve 2.

Through the valve array 52, the distributor valve 2 can be provided for dosing two different cleaning fluids, such as a UV cleaning fluid and a conventional cleaning fluid. The inlet flow path 42 between the distributor valve 2 and the first fluid source 48, in this case for UV cleaning fluid can, for example, have a first separate inlet flow path segment 60, 62 between the valve array outlet flow path 54 and the first fluid source 48 and can have a shared inlet flow path segment 64 between the valve array outlet flow path 54 and the inlet 8 of the valve array 2. The first separate inlet flow path can have, for example, a branch line 60 and a ring line 62 connected to it in terms of flow.

The inlet flow path 42 between the distributor valve 2 and the second fluid source 50, in this case water, can have for example a branch line 68 and a ring line 70 connected to it in terms of flow as inlet flow path segments.

The inlet flow path 42 between the distributor valve 2 and a third fluid source 66, in this case for conventional cleaning fluid, can have, for example, a second separate inlet flow path segment 72, 74 between the valve array outlet flow path 54 and the third fluid source 66, and can have the shared inlet flow path segment 64. The second separate inlet flow path can have, for example, a branch line 72 and a ring line 74 connected to it in terms of flow.

As a result of the valve array 52, the one distributor valve 2 in FIG. 3 can be optionally operated for the dosing of conventional cleaning fluid or UV cleaning fluid by switching the valve array 52.

In addition, a blow-out device 76, for example with a pressurized gas source 78 and a valve 80 to connect, in terms of flow, the pressurized gas source to the valve array outlet flow path 54 for blowing out fluid from the valve array outlet flow path 54, and to a connected flow path, in this case the shared inlet flow path segment 64, the distributor valve 2, the outlet flow paths 40 of the distributor valve 2 and the fluid delivery device 36, is provided for the valve array 52. As a result, when there is a media switch, such as a switch from conventional cleaning fluid to UV cleaning fluid, the entire fluid flow path can be blown out, so that the UV cleaning fluid does not come into contact with conventional cleaning fluid.

Additional valve devices 52 or additional distributor valves 2 can be connected to the ring lines 62, 70, 74.

The configuration of the components of the inventive fluid system 4 can be adjusted at will to specific requirements. For example, certain parts of the inventive fluid system 4, such as the valve array 52, can be located in a supply device 82 for a printing machine cleaning device 6, whereas other parts of the fluid system 4, especially the distributor valve 2, 2-1, can be located in the printing machine cleaning device 6 or in a printing plant to which the printing machine cleaning device 6 is assigned. It goes without saying that the valve array 52 can also be located in the printing machine cleaning device 6.

1. Distributor valve (2) of a fluid system (4) of a printing machine cleaning device (6), containing an inlet (8), at least two outlets (10), a locking element (12) and a locking element seat (14); wherein, in a closed position the locking element (12) interacts with the locking element seat (14) to separate the at least two outlets (10) from the inlet (8) in terms of flow; wherein, in an open position (16) of the locking element (12), the at least two outlets (10) are connected to the inlet (8) in terms of flow; and wherein the locking element (12) interacts with the locking element seat (14) to simultaneously separate each of the at least two outlets (10) from the inlet (8) in terms of flow or to simultaneously connect them, in terms of flow, to the inlet (8).

2. Distributor valve (2) according to claim 1,
characterized in that each of the outlets (10) extends away from a shared valve seat (18); in that the locking element (12) is moveable toward the valve seat (18) into the locking position; and in that the locking element (12) is moveable away from the valve seat (18) into the open position (16).

3. Distributor valve (2) according to one of the preceding claims,
characterized in that the locking element seat (14) extends completely around the at least two outlets (10).

4. Distributor valve (2) according to one of the preceding claims,
characterized in that the locking element seat (14) is designed to be rigid, at least in a section opposite the locking element (12), and the locking element (12) is designed to be elastic, at least in a section opposite the locking element seat (14), and vice-versa.

5. Fluid system (4) of a printing machine cleaning device (6), containing a fluid delivery device (36) with at least two fluid delivery segments (38) for the delivery of fluid; one distributor valve (2) according to one of claims 1 to 4, wherein, of the least two outlets (10) of the distributor valve (2), a dedicated outlet (10) is assigned to each of the fluid delivery segments (38); and wherein each outlet (10) of the distributor valve (2) is connected or connectable, in terms of flow, to the fluid delivery segment (38) assigned to it via a separate outlet flow path (40).

6. Fluid system (4) according to claim 5,
characterized in that at least one additional distributor valve (2-1) as claimed in one of claims 1 to 4 is provided, wherein, of the at least two outlets (10) of the additional distributor valve (2-1), a dedicated outlet (10) is assigned to each of the fluid delivery segments (38); and in that each outlet (10) of the additional distributor valve (2-1) is connected or connectable, in terms of flow, to the fluid delivery segment (38) assigned to it via a separate outlet flow path (40).

7. Fluid system (4) according to claim 5 or 6,
characterized in that each of the outlet flow paths of each distributor valve (2) has essentially identical flow resistance for the respective fluid.

8. Fluid system (4) according to one of claims 5 to 7,
characterized by a valve array (52) with a valve array outlet flow path (54) and at least two valves, which are optionally connectable, in terms of flow, to the valve array outlet flow path (54), wherein the valve array outlet flow path (54) of the valve array (52) is connected or connectable, in terms of flow, to the inlet (8) of the distributor valve (2), and a blow-out device (76) for blowing fluid out of the valve array outlet flow path (54) and a connected flow path (42, 2, 40,36).

9. Printing machine cleaning device (6) containing at least one distributor valve (2) according to one of claims 1 to 4.

10. Printing machine cleaning device (6) containing a fluid system (4) according to one of claims 6 to 9.
